(19) United States
(12) Patent Application Publication
(10) Pub. No.: US 2026/0287353 A1
(43) Pub. Date: Sep. 24, 2026

(54) Rotating Laser having at Least One Inclination Sensor

(71) Applicant: Robert Bosch GmbH, Stuttgart (DE)

(72) Inventors: Tobias Roehm, Wildberg-Sulz (DE); Tobias Zibold, Stuttgart (DE)

(21) Appl. No.: 19/569,096

(22) Filed: Mar. 17, 2026

(30) Foreign Application Priority Data
Mar. 20, 2025 (DE) 10 2025 110 743.2

(51) Int. Cl. G01C 15/00; G01C 9/34

(52) U.S. Cl. CPC G01C 15/004; G01C 9/34

(57) ABSTRACT

A rotating laser includes a housing, in which a drive unit having a stator and a rotor for rotatably driving a spindle is arranged. The stator includes a carrier tube that is arranged on a carrier plate pivotable relative to the housing. At least one inclination sensor for detecting an inclination of the carrier plate is arranged in the housing. A laser unit having a laser diode is provided, wherein the laser diode is arranged at least in sections in the carrier tube. The at least one inclination sensor is arranged on an upper side of the carrier plate facing away from the laser diode. A plurality of joining surfaces is provided for plan-parallel and/or concentric arrangement of the carrier plate, the stator, and the at least one inclination sensor relative to one another.

This application claims priority under 35 U.S.C. § 119 to patent application no. DE 10 2025 110 743.2, filed on Mar. 20, 2025 in Germany, the disclosure of which is incorporated herein by reference in its entirety.

### BACKGROUND

The present disclosure relates to a rotating laser having a housing, in which a drive unit having a stator and a rotor for rotatably driving a spindle is arranged, wherein the stator comprises a carrier tube, which is arranged on a carrier plate pivotable relative to the housing, wherein at least one inclination sensor for detecting an inclination of the carrier plate is arranged in the housing, and wherein a laser unit having a laser diode is provided, wherein the laser diode is arranged at least in sections in the carrier tube, and wherein the at least one inclination sensor is arranged on an upper side of the carrier plate facing away from the laser diode.

From the prior art, a rotating laser having a housing, in which a drive unit having a stator and a rotor for rotatably driving a spindle is arranged, is known. The stator comprises a carrier tube, which is arranged on a carrier plate pivotable relative to the housing. Furthermore, at least one inclination sensor for detecting an inclination of the carrier plate is arranged in the housing. Furthermore, a laser unit having a laser diode is provided, wherein the laser diode is arranged at least in sections in the carrier tube. The at least one inclination sensor is arranged on an upper side of the carrier plate facing away from the laser diode.

### SUMMARY

The disclosure relates to a rotating laser having a housing, in which a drive unit having a stator and a rotor for rotatably driving a spindle is arranged, wherein the stator comprises a carrier tube, which is arranged on a carrier plate pivotable relative to the housing, wherein at least one inclination sensor for detecting an inclination of the carrier plate is arranged in the housing, and wherein a laser unit having a laser diode is provided, wherein the laser diode is arranged at least in sections in the carrier tube, and wherein the at least one inclination sensor is arranged on an upper side of the carrier plate facing away from the laser diode. A plurality of joining surfaces are provided for plan-parallel and/or concentric arrangement of the carrier plate, the stator, and the at least one inclination sensor relative to one another.

The disclosure thus makes it possible to provide a rotating laser in which tolerances between the carrier plate, the stator, and the at least one inclination sensor may be reduced, at least, in a simple and reliable manner by way of the joining surfaces.

Preferably, at least one first joining surface of the plurality of joining surfaces is formed on an upper side of the carrier plate facing toward the at least one inclination sensor, and at least one second joining surface of the plurality of joining surfaces is formed on an underside of the carrier plate facing away from the at least one inclination sensor, wherein the at least one first joining surface is aligned plan-parallel to the at least one second joining surface.

Thus, a suitable carrier plate for plan-parallel arrangement of the stator and the at least one inclination sensor may be provided easily and straightforwardly.

Preferably, at least one third joining surface of the plurality of joining surfaces is formed on an outer circumference of the carrier tube, and at least one fourth joining surface of the plurality of joining surfaces is formed on an upper side, facing toward the carrier plate, of a circumferential collar of the carrier tube.

Thus, third and fourth joining surfaces may be provided in a simple manner.

Preferably, the carrier tube engages at least in sections into a recess of the carrier plate, wherein the at least one third joining surface is arranged in the recess.

Thus, precise alignment and centering of the stator at a predetermined position of the carrier plate may be made possible.

Preferably, the at least one fourth joining surface is arranged on the underside of the carrier plate facing away from the at least one inclination sensor.

Thus, a suitable arrangement of the fourth joining surface may be made possible simply and reliably.

The at least one fourth joining surface of the carrier tube preferably bears against the at least one second joining surface of the carrier plate, wherein a screw connection connects the at least one second joining surface and the at least one fourth joining surface to one another in a plan-parallel manner.

Thus, plan-parallel arrangement of the fourth and second joining surfaces, or of the circumferential collar of the carrier tube, with the carrier plate may be made possible in a simple manner.

Preferably, the carrier tube forms an interior receptacle, in which a fifth joining surface of the plurality of joining surfaces is formed, which is provided for arranging at least one bearing element for rotatably bearing the spindle.

Thus, concentric arrangement of the spindle in the carrier tube may be made possible easily and reliably.

The at least one inclination sensor preferably comprises an inclination sensor module housing having an outer side, on which at least one sixth joining surface of the plurality of joining surfaces is formed.

Thus, at least one sixth joining surface assigned to the at least one inclination sensor may be provided in a simple manner.

Preferably, the at least one sixth joining surface is arranged on a first outer side and/or on a second outer side, wherein the first and second outer sides are arranged perpendicular to one another.

Thus, first and second arrangements of the inclination sensor on the carrier plate may be made possible simply and straightforwardly.

Preferably, the carrier plate comprises, on the upper side facing toward the at least one inclination sensor, the at least one first joining surface, wherein the at least one first joining surface bears against the at least one sixth joining surface of the at least one inclination sensor, wherein the at least one first joining surface and the at least one sixth joining surface are connected to one another in a plan-parallel manner by way of a screw connection.

Thus, safe and reliable arrangement of the at least one inclination sensor on the carrier plate may be made possible.

Preferably, the inclination sensor module housing comprises an interior space, in which at least one seventh joining surface of the plurality of joining surfaces is formed, and a tubular spirit level is arranged in the interior space, wherein the tubular spirit level is arranged on the at least one seventh joining surface.

Thus, precise arrangement of the tubular spirit level in the interior space of the inclination sensor may be made possible easily and straightforwardly.

The at least one seventh joining surface is preferably arranged plan-parallel to the at least one sixth joining surface. Alternatively, the at least one seventh joining surface is arranged orthogonal to the at least one sixth joining surface.

Thus, plan-parallel arrangement of the tubular spirit level by way of the at least one sixth joining surface assigned to the inclination sensor on the carrier plate may be made possible in a simple manner.

### BRIEF DESCRIPTION OF THE DRAWINGS

The disclosure is explained in greater detail in the following description on the basis of exemplary embodiments illustrated in the drawings. It shows:

FIG. 1 a perspective view of a rotating laser according to the disclosure having a laser unit,

FIG. 2 a perspective view of a carrier plate assigned to the rotating laser of FIG. 1, having a stator assigned to the drive unit of FIG. 1 and two inclination sensors assigned to the rotating laser of FIG. 1,

FIG. 3 a perspective view of the carrier plate having the stator and the two inclination sensors of FIG. 2 as viewed from an underside,

FIG. 4 an exploded view of the carrier plate and the stator of FIG. 3,

FIG. 5 a perspective view of the carrier plate of FIG. 2 to FIG. 4 as viewed from an upper side,

FIG. 6 a perspective view of the carrier plate of FIG. 2 to FIG. 5 as viewed from an underside,

FIG. 7 a sectional view of the stator of FIG. 2 to FIG. 4 having an assigned laser diode holder,

FIG. 8 a perspective view of the stator of FIG. 2 to FIG. 4 and FIG. 7,

FIG. 9 a perspective view of the inclination sensor of FIG. 1 to FIG. 3,

FIG. 10 a perspective view of a partial section through the inclination sensor of FIG. 1 to FIG. 3 and FIG. 9 without the shielding of FIG. 2, as viewed from an underside,

FIG. 11 a perspective view of a partial section through the inclination sensor of FIG. 10, and

FIG. 12 a plan view of an underside of the inclination sensor of FIG. 1 to FIG. 3 and FIG. 9 to FIG. 11.

### DETAILED DESCRIPTION

In the figures, elements having the same or comparable function are provided with identical reference signs and are described in greater detail only once.

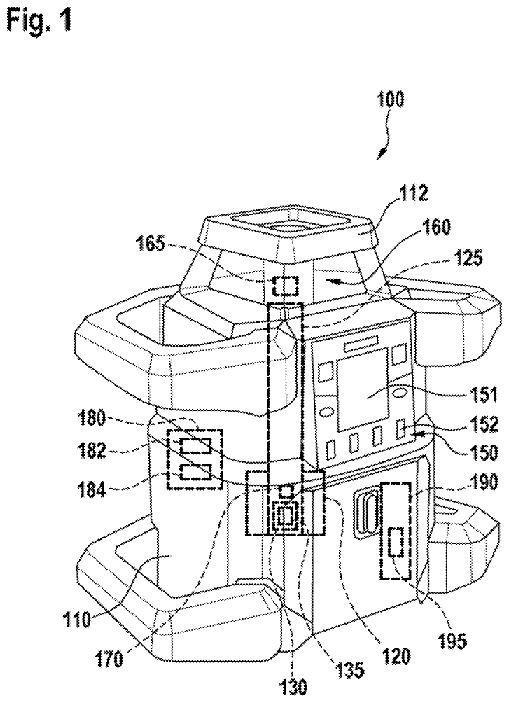

FIG. 1 shows an exemplary rotating laser 100 having a housing 110, in which a laser unit 130 having a laser diode 135 for generating a laser beam is arranged. In the context of the present disclosure, a “rotating laser” may also be understood as a construction laser or a leveling laser. Furthermore, a drive unit 120 for rotatably driving a spindle 125 is exemplarily arranged in the housing 110.

The laser unit 130 is arranged on the spindle 125 such that, by a rotation of the spindle 125, the laser beam generated by the laser unit 130 rotates in an assigned plane. For this purpose, a rotating head 160 having a beam deflector 165 is preferably assigned to the spindle 125. The beam deflector 165 is preferably configured to deflect the laser beam, whereby the laser beam projects the assigned plane. Depending on the configuration of the rotary laser 100, the projected plane may extend horizontally, vertically, or, for example, with a defined inclination angle relative to the ground surface. Preferably, the drive unit 120 is configured to be an electric motor.

Furthermore, an electronics unit 190 having a control and monitoring device 195 is preferably arranged in the housing 110. The control and monitoring device 195 is preferably configured to regulate laser power of the laser unit 130 as a function of an operating mode. Here, a rotational speed of the spindle 125 of the drive unit 120 is controlled or regulated. For this purpose, a determination unit 170 is preferably assigned to the spindle 125.

A protective cage 112 assigned to the rotating head 160 is provided on the housing 110 for protecting against an impact of the rotating head 160.

A user interface 150 having a display 151 and an input unit 152 is preferably assigned to the electronics unit 190. The operating unit 150 is preferably connected to the electronics unit 190, in particular to the control and monitoring device 195, in terms of control or regulation. The input unit 152 preferably comprises at least a keypad. Alternatively, the input unit 152 comprises a rotating controller, a touchscreen, a slider, a remote control, or the like. By way of the input unit 152, a user may input, for example, a rotational speed for the spindle 125. Alternatively, the rotational speed of the laser unit 130 is automatically controllable in one operating mode.

Preferably, the rotating laser 100 comprises a leveling unit 180. The leveling unit 180 preferably comprises at least one inclination sensor 184, which is configured to determine an inclination of the rotating head 160, in particular, of the beam deflector 165, and/or of the laser unit 130 relative to a predefined direction, preferably a horizontal direction, or relative to the vertical. Furthermore, the leveling unit 180 preferably comprises at least one inclination adjustment motor 182, which is configured to align the rotating head 160, in particular, the beam deflector 165, and/or the laser unit 130 relative to the vertical as a function of a position determined by way of the at least one inclination sensor 184, preferably an inclination of the laser unit 130 and/or of the rotating head 160.

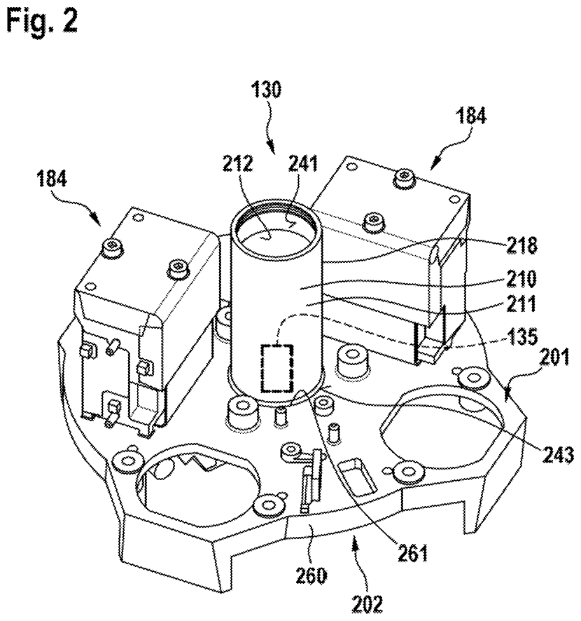

FIG. 2 shows a carrier plate 260 assigned to the rotating laser 100 of FIG. 1. The carrier plate 260 is preferably movably mounted in the housing 110 of the rotating laser 100 of FIG. 1. The carrier plate 260 comprises an upper side 201 and an underside 202. By way of example, at least one, illustratively two, inclination sensors 184 of the leveling unit 180 of FIG. 1 are arranged on the upper side 201. Alternatively, three inclination sensors 184 may be provided.

Furthermore, FIG. 2 shows a stator 210 assigned to the drive unit 120 of FIG. 1. The stator 210 exemplarily comprises a cylindrical carrier tube 211 having an interior receptacle 212. In the interior receptacle 212, a bearing arrangement for bearing the spindle 125 of FIG. 1 is preferably arrangeable. Preferably, the bearing arrangement comprises at least one bearing element. For receiving the at least one bearing element in the interior receptacle 212, the interior receptacle 212 comprises at least one bearing location 241. Furthermore, the laser diode 135 of the laser unit 130 of FIG. 1 is arranged at least in sections in the interior receptacle 212 of the carrier tube 211. Preferably, the carrier tube 211 comprises, on its outer circumference 218, a bearing surface 243.

Furthermore, the carrier plate 260 comprises a recess 261. Preferably, the recess 261 is configured to be a central recess 261. The carrier plate 260 is preferably provided for arranging the carrier tube 211 of the stator 210. Here, the carrier tube 211 is preferably configured to engage at least in sections into the recess 261 of the carrier plate 260. Preferably, the bearing surface 243 of the carrier tube 211 is arranged in the recess 261.

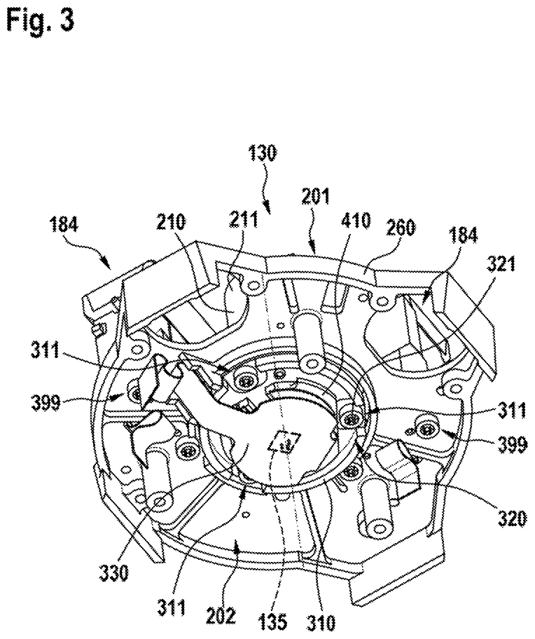

FIG. 3 shows the carrier plate 260 of FIG. 2 as viewed from the underside 202. In this context, FIG. 3 illustrates a circumferential collar 310 assigned to the carrier tube 211 of the stator 210. The circumferential collar 310 preferably has a larger diameter than the recess 261 of FIG. 2 of the carrier plate 260. The circumferential collar 310 is preferably connected to the carrier plate 260 by way of a screw connection 320. For this purpose, the circumferential collar 310 comprises at least one, three, screw arrangement locations 311, in which a respective screw 321 for forming the screw connection 320 is arranged.

Furthermore, the at least one inclination sensor 184 is preferably fixed on the carrier plate 260 by way of a screw connection 399. Two inclination sensors 184 are shown, which are fixed on the carrier plate 260 by way of a screw connection 399. Here, a screw for forming the screw connection 399 is arranged on the underside 202 of the carrier plate 260. Preferably, a laser diode holder 410 is arranged in sections in the interior receptacle 212 of FIG. 2 of the carrier tube 211. Preferably, a circuit board 330 is assigned to the laser diode holder 410. Preferably, the laser diode 135 of FIG. 1 and FIG. 2 is arranged on the circuit board 330. Preferably, the circuit board 330 is configured to be a flexible and foldable circuit board. Preferably, the laser diode 135 is arranged in sections in the laser diode holder 410 and/or the interior receptacle 212 of the carrier tube 210.

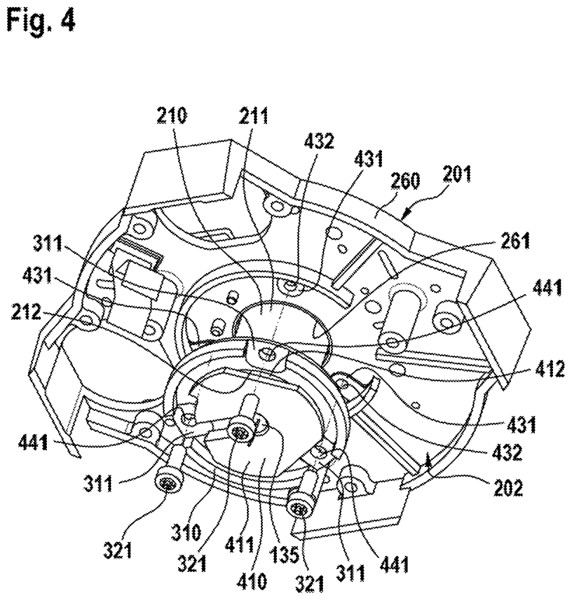

FIG. 4 shows the carrier plate 260 of FIG. 3 having the stator 210, the laser diode holder 410, and the laser diode 135 of FIG. 3. In this context, FIG. 4 illustrates the laser diode holder 410, which comprises a cylindrical base body 412 having a circumferential collar 411. The cylindrical base body 412 is arrangeable in the interior receptacle 212 of the carrier tube 211 and is arranged therein in FIG. 4. Preferably, the cylindrical base body 412 is press-fitted into the interior receptacle 212 of the carrier tube 211.

Furthermore, FIG. 4 shows a recess 441 assigned to one of the screw arrangement locations 311 of the circumferential collar 310 for arranging a screw 321. Furthermore, the carrier plate 260 comprises, on its underside 202, a recess 432 assigned to the recess 441. A joining surface 431 is assigned to the recess 432. The joining surface 431 is preferably configured to be a planar surface. Preferably, the joining surface 431 is arranged parallel to the underside 202 of the carrier plate 260. For this purpose, the joining surface 431 is configured in a web-like manner.

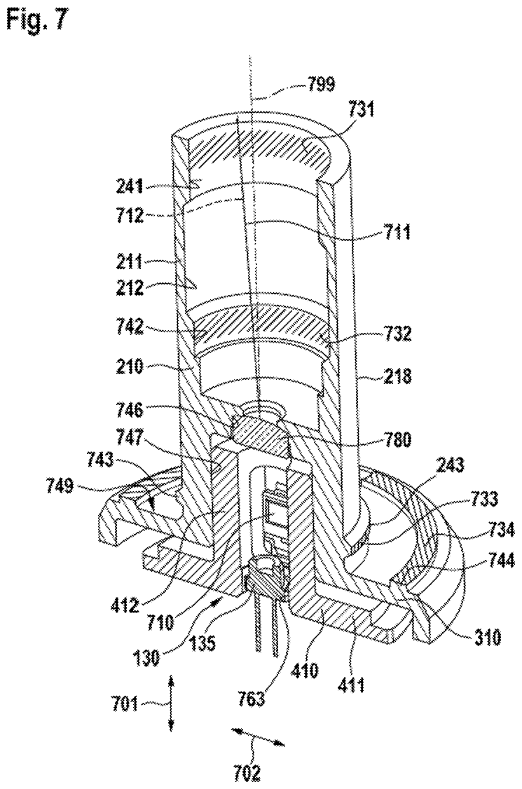

The circumferential collar 310 of the carrier tube 211 preferably comprises, on its side facing toward the carrier plate 260 (749 in FIG. 7), a further joining surface (734 in FIG. 7). Preferably, the two joining surfaces 431, (734 in FIG. 7) are arranged plan-parallel to one another. In the context of the present disclosure, the term “plan-parallel” is understood as an exactly parallel arrangement with a comparatively small tolerance of the two joining surfaces relative to one another. The two joining surfaces 431, (734 in FIG. 7) are preferably formed by face turning, face milling, or surface grinding.

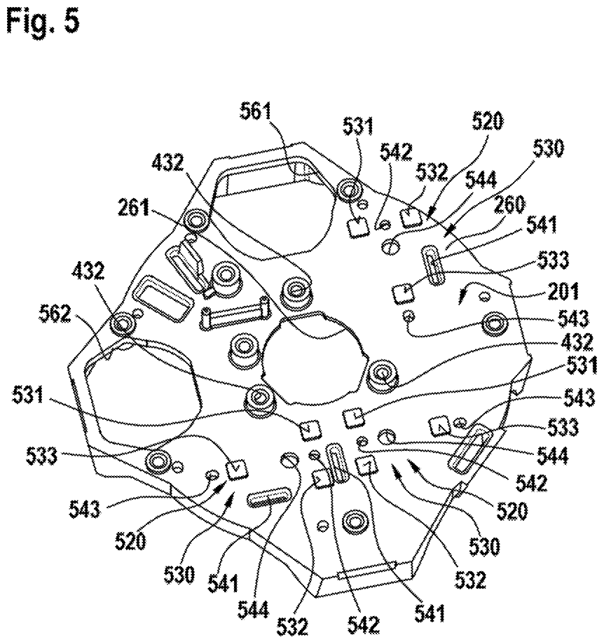

FIG. 5 shows the carrier plate 260 of FIG. 2 to FIG. 4 as viewed from the upper side 201. The carrier plate 260 comprises at least one, three, mounting locations 530 for arranging the inclination sensor 184 of FIG. 1 to FIG. 4. Each mounting location 530 preferably comprises a joining surface 520. The joining surface 520 is preferably configured to be a planar surface. Preferably, the joining surface 520 is arranged parallel to the upper side 201 of the carrier plate 260. For this purpose, the joining surface 520 is configured in a web-like manner.

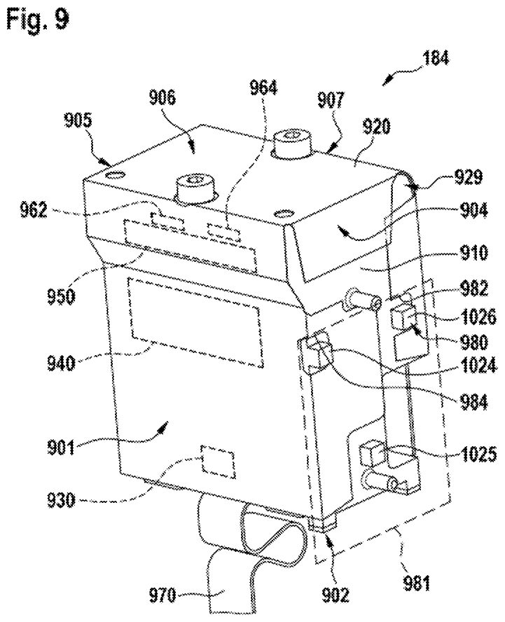

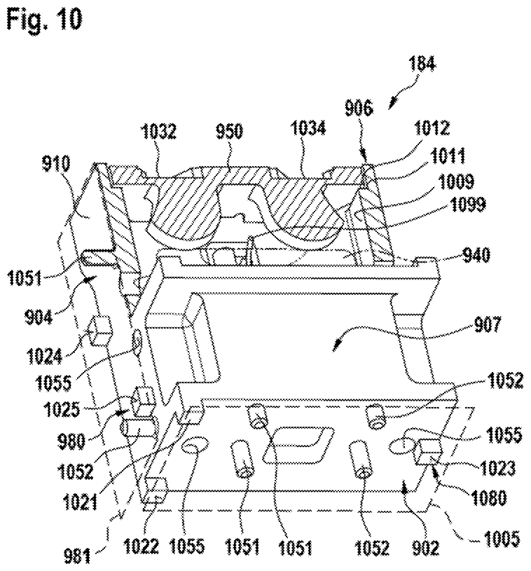

Preferably, the three mounting locations 530, or the three joining surfaces 520, are arranged in a common plane. Alternatively, each joining surface 520 has an assigned plane. Preferably, each joining surface 520 comprises at least two, three, subregions 531, 532, 533. Preferably, the three subregions 531, 532, 533 are arranged in a triangle. Preferably, a recess 544 for fixing the inclination sensor 184 is arranged within the triangle. Here, the recess 544 may be arranged, for example, at the centroid of the triangle. Furthermore, two receptacles 542, 543 for receiving centering pins (1051, 1052 in FIG. 10) of the inclination sensor 184 are preferably assigned to each mounting location 530. Furthermore, each mounting location 530 is assigned to a slot-shaped recess 541 for passing through a circuit board (970 in FIG. 9) of the inclination sensor 184.

Furthermore, FIG. 5 illustrates the preferably central recess 261 of the carrier plate 260 for arranging the stator 210, as well as the preferably three recesses 432 for fixing the circumferential collar 310 of the carrier tube 211 of the stator 210 of FIG. 2 to FIG. 4. Furthermore, the carrier plate 260 preferably comprises two receptacles 561, 562, which are configured to receive a respective inclination adjustment motor 182 of the leveling unit 180 of FIG. 1.

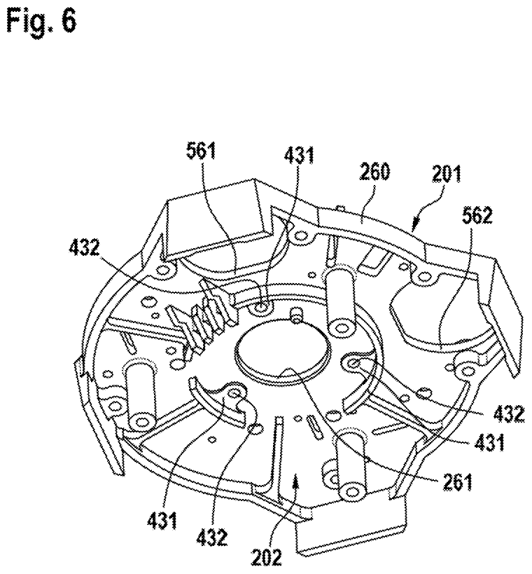

FIG. 6 shows the carrier plate 260 of FIG. 2 to FIG. 5 as viewed from the underside 202. In this context, FIG. 6 illustrates the three joining surfaces 431 having the assigned recesses 432. Preferably, the joining surfaces 431 on the underside 202 of the carrier plate 260 are arranged plan-parallel to the joining surfaces 520 of FIG. 5 on the upper side 201 of the carrier plate 260. Preferably, the joining surfaces 431, 520 are formed on raised sections of the carrier plate 260 and are manufactured by face milling, face turning, or surface grinding.

FIG. 7 shows the stator 210 of FIG. 2 to FIG. 4 having the carrier tube 211 and the laser diode holder 410 of FIG. 4 arranged in sections in the carrier tube 211, having the laser diode 135, a photodiode 710, as well as a collimation lens 780. The laser diode 135 and/or the photodiode 710 are arranged at least in sections in an interior receptacle 763 of the laser diode holder 410. Furthermore, the laser diode holder 410 is arranged in sections in a, lower, receptacle 747 assigned to the interior receptacle 212 of the carrier tube 211.

A monitor diode is preferably assigned to the laser diode 135. The monitor diode is preferably configured to measure laser power assigned to the laser diode 135. Here, the monitor diode may be a monitor diode integrated into the laser diode 135. Preferably, the laser unit 130 comprises the photodiode 710, which is provided for a measurement of the laser power independent of the monitor diode. The photodiode 710 is arranged perpendicular to the laser diode 135.

Preferably, the laser unit 130 comprises the collimation lens 780 for collimating the laser beam. Here, the collimation lens 780 is preferably arranged and preferably fixed in a receiving section 746 of the interior receptacle 212 of the stator 210. The collimation lens 780 is preferably fixed in the interior receptacle 212, or the receiving section 746, by way of a material-bonded connection and/or a press connection.

A laser beam 711 generated by the laser diode 135 and collimated by the collimation lens 780, as well as a laser axis 712 assigned to the laser beam 711, are not arranged congruently with an axis of rotation 799 of the spindle 125 of FIG. 1 or of the carrier tube 211, but are arranged at an inclination relative thereto, by way of example. Such an oblique position and/or a lateral offset may occur in the mounting of the laser diode 135 in the laser diode holder 410, mounting of the laser diode holder 410 in the carrier tube 211, and/or mounting of the collimation lens 780 in the carrier tube 211.

Preferably, the carrier tube 211 is machined by adjustment turning in order to compensate an oblique position and/or a lateral offset of the laser beam 711 relative to the axis of rotation 799 within predefined tolerances, or for congruent alignment of the axis of rotation 799 of the spindle 125 of FIG. 1 with the laser beam 711 of the laser diode 135.

In a conventional turning process, a workpiece is clamped on a spindle, which is stationary and may only execute a rotation. Therefore, only rotationally symmetrical geometries may be produced, or helical geometries, for example, threads. In adjustment turning, the spindle may additionally execute a lateral movement. The different movements, for example rotation, lateral movement of the spindle, feed of the tool, may be precisely controlled by way of a computer. In this manner, “non-round” contours may be produced. This capability enables correction of an oblique laser axis, such as, for example, the laser axis 712.

As described above, at least one, illustratively two bearing locations 241, 742 for arranging bearing elements for rotatably supporting the spindle 125 of FIG. 1 are provided in the interior receptacle 212 of the carrier tube 211. Preferably, the carrier tube 211 is machined at least one of the at least two bearing locations 241, 742 by way of adjustment turning for concentric alignment of the spindle 125 with the laser beam 711. Preferably, the bearing location 241 forms a joining surface 731, and the bearing location 742 forms a joining surface 732, which are provided for arrangement of at least one bearing element for rotatably mounting the spindle 125. Preferably, the joining surfaces 731, 732 are formed as cylindrical surfaces.

Furthermore, the carrier tube 211 preferably comprises, on the outer circumference 218, a joining surface 733 and/or, on an upper side 749 of the circumferential collar 310, a joining surface 734. Preferably, the joining surface 733 is assigned to the contact surface 243 and is, for example, arrangeable in the recess 261 of FIG. 2 and FIG. 4 to FIG. 6 of the carrier plate 260 of FIG. 2 to FIG. 6. Preferably, the joining surface 734 is arrangeable on the underside 202 of FIG. 2 to FIG. 6 of the carrier plate 260 of FIG. 2 to FIG. 6. Preferably, the joining surface 734 of the carrier tube 211 bears against the at least one joining surface 431 of the carrier plate 260 in the assembled state of the carrier tube 211 on the carrier plate 260, on the carrier plate 260. Here, the screw connection 320 of FIG. 3 connects the at least one joining surface 431 of the carrier plate 260 and the at least one joining surface 734 of the carrier tube 211 plan-parallel to one another.

Preferably, the joining surface 733 is formed as a cylindrical surface. Preferably, the joining surface 734 is formed as a planar surface. Preferably, a cylinder axis assigned to the joining surfaces (731, 732, 733) configured to be cylindrical surfaces is aligned perpendicular to a joining surface (734) configured to be a planar surface.

Preferably, the joining surface 733 is formed as a web-like extension 743 on the outer circumference 218 of the carrier tube 211. Here, the web-like extension 743 is preferably arranged in a radial direction 702 of the carrier tube 211. The joining surface 734 is preferably formed as a web-like extension 744 of the circumferential collar 310 of the carrier tube 211. Here, the web-like extension 744 is preferably arranged in an axial direction 701, or along the longitudinal extent of the carrier tube 211.

Alternatively, or optionally, the carrier tube 211 is machined by adjustment turning at the joining surface 733 for concentric alignment of the spindle 125 or of the laser beam 711 relative to the carrier plate 260 of FIG. 2 to FIG. 6. Alternatively, or optionally, the carrier tube 211 is machined at the joining surface 734 by way of adjustment turning for orthogonal alignment of the spindle 125, or of the laser beam 711, relative to the carrier plate 260.

Preferably, in an adjustment turning of the stator 210, that is to say, of the carrier tube 211, at least one of the surfaces 731, 732, 733, 734 assigned to the carrier tube 211 is machined based on a virtual axis of rotation defined by the laser axis 712, in particular, machined by cutting. Here, preferably at least one of the bearing locations 241, 742 forms such an assigned surface. Alternatively, or optionally, one of the two joining surfaces 733, 734 forms such an assigned surface. By machining the carrier tube 210 along the virtual axis of rotation, preferably at least one of the assigned surfaces 731, 732, 733, 734 is machined such that the axis of rotation 799 of the spindle 125 is arranged congruently with the laser beam 711.

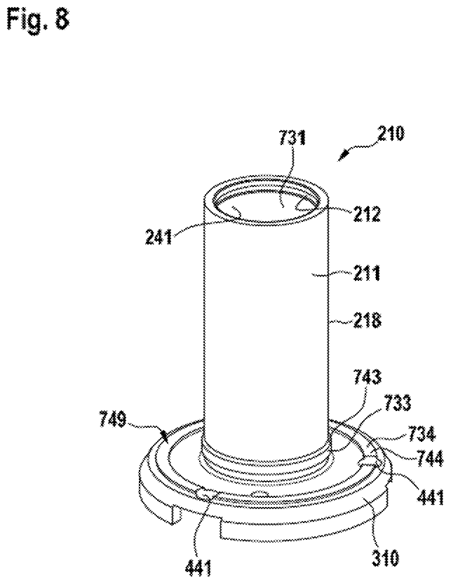

FIG. 8 shows the stator 210 of FIG. 7 having the joining surfaces 731, 733, 734. In this context, FIG. 8 illustrates the web-like extension 743 arranged on the outer circumference 218 of the carrier tube 211 for forming the joining surface 733 and the web-like extension 744 arranged on the circumferential collar 310 of the carrier tube 211 for forming the joining surface 734.

FIG. 9 shows the inclination sensor 184 of FIG. 1 to FIG. 4. The inclination sensor 184 comprises an inclination sensor module housing 910 arranged in the housing 110 of the rotating laser 100 of FIG. 1. The inclination sensor module housing 910 preferably comprises a substantially cuboid base body having a first, right side surface 904, a second, lower side surface 902 arranged perpendicular to the first side surface 904, as well as a third, rear side surface 907 and a fourth side surface 901 opposite the third side surface 907. Furthermore, a fifth, left side surface 905 is provided opposite the first side surface 904, and an upper side 906 opposite the second side surface 902.

An infrared shielding 920 is preferably arranged on an outer circumference 929 of the inclination sensor module housing 910. Preferably, the infrared shielding 920 is arranged at least in sections on the inclination sensor module housing 910. The infrared shielding 920 has an impermeability to wavelengths in the infrared frequency band such that wavelengths in the infrared frequency band may not exit the inclination sensor module housing 910. For example, the infrared shielding 920 may be formed as an aluminum-laminated adhesive film. Alternatively, the infrared shielding 920 is formed as a stamped and bent part. Here, the infrared shielding 920 preferably encloses the inclination sensor module housing 910 at least in sections. The infrared shielding 920 is bent around the inclination sensor module housing 910. Preferably, the infrared shielding 920 is arranged at least on the third and/or the fourth side surface 907, 901. The infrared shielding 920 is arranged at least in sections on the side surfaces 901, 904, 905, 907 and on the upper side 906.

By way of example, the infrared shielding 920 comprises at least one recess 982, 984. The recesses 982, 984 are preferably configured to enable parts assigned to the inclination sensor module housing 910 to pass through.

Preferably, the inclination sensor module housing 910 comprises at least one joining surface 980, 1080 in FIG. 10 on at least one side surface 902, 904 for flush alignment of the inclination sensor module housing 910 on the carrier plate 260 of FIG. 2 to FIG. 6. Preferably, the at least one joining surface 980, 1080 in FIG. 10 is arranged plan-parallel to a joining surface 520 of FIG. 5 of the carrier plate 260 of FIG. 2 to FIG. 6. This may enable precise arrangement of the inclination sensor 184 relative to the laser unit 130 of FIG. 1, whereby accurate and precise measurement of an inclination of the laser unit 130 of FIG. 1 may be enabled.

Preferably, the at least one joining surface 980, 1080 in FIG. 10 is divided into at least two partial surfaces 1024, 1025, 1026, (1021, 1022, 1023 in FIG. 10) spaced apart from one another. Here, the at least two partial surfaces 1024, 1025, 1026, (1021, 1022, 1023 in FIG. 10) spaced apart from one another are arranged in a common plane 981 (and 1005 in FIG. 10).

The partial surfaces 1024, 1025, 1026 are assigned to the plane 981, which is arranged parallel to the right side surface 904 of the inclination sensor module housing 910. The side surface 902 is preferably arranged perpendicular to the side surface 904.

The partial surfaces 1024, 1025 of the inclination sensor module housing 910 extend through the recesses 982, 984 of the infrared shielding 920. In particular, the recesses 982, 984 are preferably assigned to at least one joining surface 980 associated with the inclination sensor module housing 910. The joining surface 980 is preferably configured to be a planar surface. Here, the joining surface 980 may be arranged parallel to the side surface 904 of the inclination sensor module housing 910. For this purpose, the joining surface 980 is configured in a web-like manner. Preferably, the inclination sensor module housing 910 is configured to be a cast part. It should be noted that the at least one joining surface 980, 1080 in FIG. 10 is a planar surface of the inclination sensor module housing 910, which is formed as a cast part, and may be produced by face turning, face milling, or surface grinding.

In the inclination sensor module housing 910, a tubular spirit level 940 and an infrared emitter 930 are preferably arranged for determining an alignment of the laser unit 130 of FIG. 1. Preferably, a light guide 950 spaced apart from the tubular spirit level 940 is arranged in the inclination sensor module housing 910. The second side surface 902 is exemplarily arranged parallel to a light guide 950. Furthermore, the inclination sensor 184 in its inclination sensor module housing 910 preferably comprises at least one photodiode 962, 964. Two photodiodes 962, 964 are provided.

The light guide 950 preferably comprises glass or transparent plastic. For example, the light guide 950 is manufactured from glass or transparent plastic. Preferably, the light guide 950 is fixed on the inclination sensor module housing 910. Here, the light guide 950 is fixed on the inclination sensor module housing 910, for example by way of a screw connection. Alternatively or optionally, the light guide 950 is fixed on the inclination sensor module housing 910, for example by way of an adhesive bond. According to one embodiment, the light guide 950 is formed in one piece with the inclination sensor module housing 910.

Furthermore, the inclination sensor 184 preferably comprises a flexible circuit board 970. Preferably, the infrared emitter 930 and the at least one photodiode 962, 964 are arranged on the flexible circuit board 970. The flexible circuit board 970 is preferably arranged on the outer circumference 929 of the inclination sensor module housing 910. Here, the flexible circuit board 970 preferably encloses the inclination sensor module housing 910 at least in sections. The flexible circuit board 970 is, for example, arranged in sections between the inclination sensor module housing 910 and the infrared shielding 920.

FIG. 10 shows the inclination sensor 184 of FIG. 9. As described above, the inclination sensor module housing 910 preferably comprises at least one joining surface 980, 1080 on at least one side surface 902, 904 for flush alignment of the inclination sensor module housing 910 on the carrier plate 260 of FIG. 2 to FIG. 6. The at least one joining surface 980, 1080 is preferably divided into at least two partial surfaces 1024, 1025, 1026 spaced apart from one another in FIGS. 9, 1021, 1022, 1023. Here, the at least two partial surfaces 1024, 1025, 1026 in FIGS. 9, 1021, 1022, 1023 may be arranged in a common plane 981, 1005, spaced apart from one another.

The partial surfaces 1021, 1022, 1023 assigned to the joining surface 1080 are assigned to the plane 1005, which is arranged parallel to the lower side surface 902 of the inclination sensor module housing 910. The joining surface 1080 is preferably configured to be a planar surface. Preferably, the joining surface 1080 is arranged parallel to the side surface 902 of the inclination sensor module housing 910. For this purpose, the joining surface 1080 is preferably configured in a web-like manner.

Preferably, at least one centering pin 1051, 1052 is assigned to the side surface 904 and/or the side surface 902. The centering pins 1051, 1052 are configured to position the inclination sensor 184 uniquely and repeatably on the carrier plate 260 of FIG. 2 to FIG. 6. Two centering pins 1051, 1052 are respectively assigned to the side surface 902 and one centering pin 1051, 1052 is respectively assigned to the side surface 904. Furthermore, the side surface 902 and/or the side surface 904 preferably comprises at least one recess 1055 for fixation on the carrier plate 260 of FIG. 2 to FIG. 6.

Preferably, the tubular spirit level 940 is arranged in an interior receptacle 1009 of the inclination sensor module housing 910. For positioning the tubular spirit level 940 in the interior receptacle 1009 of the inclination sensor module housing 910, a resilient element 1099 is provided. The resilient element 1099 preferably biases the tubular spirit level 940 at its outer circumference into a predefined position. By way of example, the resilient element 1099 is configured to be a wire spring or leaf spring.

Preferably, the tubular spirit level 940 is fixed in the interior receptacle 1009 of the inclination sensor module housing 910 by way of an adhesive bond. Preferably, an adhesive forming the adhesive bond is curable by way of UV light. According to one embodiment, the inclination sensor module housing 910 comprises, on the side surface 901 or on the upper side 906, a UV light introduction region 1012 for curing the adhesive, which fixes the tubular spirit level 940 in the inclination sensor module housing 910. Here, the adhesive is cured, for example, by way of a UV lamp.

Furthermore, the light guide 950 is received in a receptacle 1011 assigned to the interior receptacle 1009 and facing the upper side 906 of the inclination sensor module housing 910. Preferably, the light guide 950 comprises, on its side facing away from the tubular spirit level 940, or facing toward the upper side 906, at least one receptacle 1032, 1034 for receiving at least one photodiode 962, 964 of FIG. 9. The receptacle 1032 is provided for receiving the photodiode 962 of FIG. 9 and the receptacle 1034 is provided for receiving the photodiode 964 of FIG. 9. Alternatively, a plurality of photodiodes 962, 964 of FIG. 9 may also be arrangeable in a common receptacle 1032, 1034.

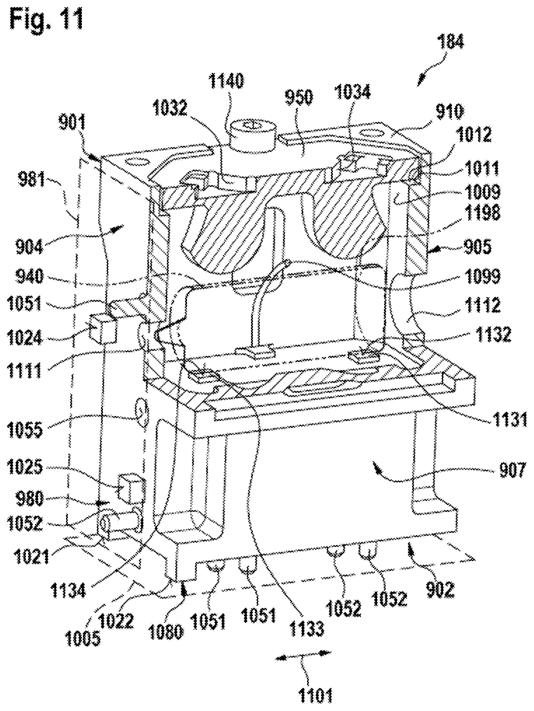

FIG. 11 shows the inclination sensor 184 of FIG. 1 to FIG. 4, FIG. 9, and FIG. 10. In this regard, FIG. 11 clarifies the arrangement of the light guide 950 in the receptacle 1011 of the inclination sensor module housing 910. The light guide 950 is fixed to the inclination sensor module housing 910 by way of at least one screw 1140. Alternatively, the light guide 950 is fixed on the inclination sensor module housing 910 by way of an adhesive bond. However, the light guide 950 may also be fixed in the inclination sensor module housing 910 merely by arranging it in the receptacle 1011 of the inclination sensor module housing 910, since the receptacle 1011 tapers toward the tubular vial 940, or downward, into the interior receptacle 1009 of the inclination sensor module housing 910.

Furthermore, FIG. 11 shows the arrangement of the tubular spirit level 940 in the interior receptacle 1009 of the inclination sensor module housing 910. Preferably, the tubular vial 940 is supported on at least one, on two support elements 1131, 1133 in the interior receptacle 1009. Here, the at least one supporting element 1031, 1033 preferably comprises at least one joining surface 1132, 1134. The supporting element 1031 comprises the joining surface 1132 and the supporting element 1133 comprises the joining surface 1134. Preferably, the tubular vial 940 bears with its outer circumference 1198 against the joining surfaces 1132, 1134. Preferably, the joining surfaces 1132, 1134 are configured to be planar surfaces.

Furthermore, the inclination sensor module housing 910 preferably comprises, on the left side surface 904 and on the right side surface 905, in each case a recess 1111, 1112 for displacing the tubular vial 940 along its longitudinal extent 1101. Here, the side surface 905 is, for example, opposite the side surface 904. The recess 1111 is assigned to the left side surface 904, and the recess 1112 is assigned to the right side surface 905.

Preferably, the at least one joining surface 1132, 1134 is arranged plan-parallel to the at least one joining surface 980. Alternatively, the at least one joining surface 1132, 1134 is arranged orthogonal to the at least one joining surface 1080.

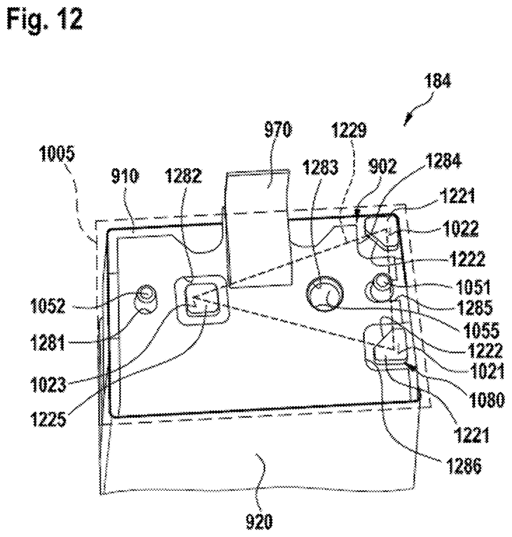

FIG. 12 shows the inclination sensor 184 of FIG. 1 to FIG. 4, FIG. 9 to FIG. 11, and illustrates the side surface 902 having the joining surface 1080. According to FIG. 12, the preferably three partial surfaces 1021, 1022, 1023 are arranged in a triangle 1229. Preferably, the left partial surface 1023 comprises a rectangular base surface 1225. Preferably, the partial surfaces 1021, 1022 likewise comprise a rectangular base surface 1221. Preferably, the base surfaces 1221 of the partial surfaces 1021, 1022 each comprise a flattening 1222. Preferably, the flattening 1222 is arranged facing a centroid of the triangle 1229.

Preferably, the circuit board 970 comprises a recess 1283 assigned to the recess 1055. Thus, a screw connection for fixing the inclination sensor 184 to the carrier plate 260 may be formed between the recess 1055 of the inclination sensor module housing 910 and the recess 544 of FIG. 5 of the carrier plate 260 of FIG. 2 to FIG. 6. Preferably, the circuit board 970 comprises recesses 1282, 1284, 1286 assigned to the partial surfaces 1021, 1022, 1023, wherein the recess 1282 is assigned to the partial surface 1023, the recess 1284 is assigned to the partial surface 1022, and the recess 1286 is assigned to the partial surface 1021. Furthermore, the circuit board 970 comprises recesses 1281, 1285 assigned to the centering pins 1051, 1052 of the inclination sensor module housing 910, in particular, of the joining surface 1080 of the side surface 902. The recess 1281 is preferably assigned to the centering pin 1052 and the recess 1285 is assigned to the centering pin 1051.

What is claimed is:

1. A rotating laser, comprising:
a housing;
a carrier plate pivotable relative to the housing;
a drive unit arranged in the housing and having a stator and a rotor configured to rotatably drive a spindle, wherein the stator includes a carrier tube that is arranged on the carrier plate;
at least one inclination sensor arranged in the housing and configured to detect an inclination of the carrier plate,
a laser unit having a laser diode, wherein the laser diode is arranged at least in sections in the carrier tube, and wherein the at least one inclination sensor is arranged on an upper side of the carrier plate facing away from the laser diode; and
a plurality of joining surfaces configured for plan-parallel and/or concentric arrangement of the carrier plate, the stator, and the at least one inclination sensor relative to one another.

2. The rotating laser according to claim 1, wherein:
on an upper side of the carrier plate facing the at least one inclination sensor, at least one first joining surface of the plurality of joining surfaces is formed,
on an underside of the carrier plate facing away from the at least one inclination sensor, at least one second joining surface of the plurality of joining surfaces is formed, and
the at least one first joining surface is aligned plan-parallel to the at least one second joining surface.

3. The rotating laser according to claim 2, wherein:
on an outer circumference of the carrier tube, at least one third joining surface of the plurality of joining surfaces is formed, and
on an upper side of a circumferential collar of the carrier tube facing the carrier plate, at least one fourth joining surface of the plurality of joining surfaces is formed.

4. The rotating laser according to claim 3, wherein:
the carrier tube engages at least in sections in a recess of the carrier plate, and the at least one third joining surface is arranged in the recess.

5. The rotating laser according to claim 3, wherein the at least one fourth joining surface is arranged on the underside of the carrier plate facing away from the at least one inclination sensor.

6. The rotating laser according to claim 4, wherein:
the at least one first joining surface is aligned plan-parallel to the at least one second joining surface,
the at least one fourth joining surface of the carrier tube bears against the at least one second joining surface of the carrier plate, and
a screw connection connects the at least one second joining surface and the at least one fourth joining surface plan-parallel to one another.

7. The rotating laser according to claim 3, wherein the carrier tube is configured to form an interior receptacle, in which a fifth joining surface of the plurality of joining surfaces is formed, which is configured for arrangement of at least one bearing element for rotatably mounting the spindle.

8. The rotating laser according to claim 2, wherein the at least one inclination sensor includes an inclination sensor module housing having an outer side, on which at least one sixth joining surface of the plurality of joining surfaces is formed.

9. The rotating laser according to claim 8, wherein:
the at least one sixth joining surface is arranged on a first outer side and/or on a second outer side, and
the first outer side and the second outer side are arranged perpendicular to one another.

10. The rotating laser according to claim 8, wherein:
the carrier plate includes the at least one first joining surface on the upper side facing the at least one inclination sensor,
the at least one first joining surface bears against the at least one sixth joining surface of the at least one inclination sensor, and
the at least one first joining surface and the at least one sixth joining surface are connected plan-parallel to one another by way of a screw connection.

11. The rotating laser according to claim 8, wherein:
the inclination sensor module housing defines an interior space, in which at least one seventh joining surface of the plurality of joining surfaces is formed,
a tubular vial is arranged in the interior space, and
the tubular vial is arranged on the at least one seventh joining surface.

12. The rotating laser according to claim 11, wherein the at least one seventh joining surface is arranged plan-parallel to the at least one sixth joining surface.

13. The rotating laser according to claim 11, wherein the at least one seventh joining surface is arranged orthogonal to the at least one sixth joining surface.
